(19) United States
(12) Patent Application Publication
(10) Pub. No.: US 2005/0237153 A1
(43) Pub. Date: Oct. 27, 2005

(54) Device for electronically pricing product on a shelf

(76) Inventor: Jack Chen, Oak Brook, IL (US)

Correspondence Address: ROBERT L. MARSH, 54 DANADA DRIVE, P.O. BOX 4468, WHEATON, IL, 60187-4468, US

(21) Appl. No.: 10/828,725

(22) Filed: Apr. 21, 2004

(51) Int. Cl. G06F 17/60

(52) U.S. Cl. 340/5.91; 705/20

(57) ABSTRACT

To electronically price product along a store shelf, a bus containing a plurality of electrical contact strips is affixed along the visible end of the shelf. Electronic price display units are removably attachable anywhere along the length of the bus. Power and pricing information is provided to the price display units from a control unit connected to one end of the bus. Pricing information is transmitted by RF from a remote control station to the control units in the store which in turn send pricing information to the price display units attached to the bus.

The present invention relates to a device for electronically displaying the prices of various products along a shelf and entering changes to the displayed price from a remote location.

### BACKGROUND OF THE INVENTION

Grocery stores, supermarkets, and the like display their goods on long shelves with numerous different products displayed for sale along each of the shelves. The forward edge of the shelves is adapted to receive a price display, and one price display is positioned below each of the products offered for sale. In a large store, hundreds of products, perhaps thousands of products, may be offered for sale, with the price of each of the products stated on a display. The price of a product may change many times during the course of a single year. The product may be offered for sale, requiring the display of a lesser price. At the expiration of the sale, the display must again be changed to reflect the full price of the product. Price changes occur in response to increased costs from manufacturers, inflation, changes in demand, excess inventory, and so forth. A large store may have a hundred or more price changes to enter on a daily basis, all of which is currently manually undertaken by staff members. Department stores and grocery stores have estimated that the entering of price changes consumes eight dollars per day for each twenty-foot length of shelf in a store. It would be desirable, therefore, to provide a means for electronically pricing products on a shelf, where the price of the product can be altered from a remote location in the office of the store manager.

Prior efforts have been made to provide electronic pricing of products along shelves. In one such prior effort, a pricing unit includes a battery operated radio frequency receiver (RF receiver) connected to a liquid crystal display that is attachable to the forward edge of a shelf. Transmitters or repeaters in the ceiling of the store convey pricing information from a computer connected to a transmitter in the central office of the store. The store manager can then enter price changes for each of the products in the store by changing the price of the product as displayed on the screen after which the pricing changes will be sent by RF signal to the pricing unit. Although such devices permit price changes to be electronically entered, a single store may employ thousands of pricing units, each of which has its own battery, such that a considerable effort must be undertaken to maintain the continuous operation of the pricing units. Furthermore, the cost of purchasing and maintaining thousands of such pricing units is considerable. It would be desirable, therefore, to provide a device for electronically displaying and changing prices that would be less expensive to acquire and not be dependent upon batteries for operation.

### SUMMARY OF THE INVENTION

Briefly, the present invention is embodied in a device for electronically pricing the products along a shelf and includes a bus having a plurality of contact strips therein that is attached to the forward edge of the shelf. The bus is configured to removably receive individual price display units that are attachable thereto and have electrical contact therein that engage the contact strips within the bus. One of the contact strips on the bus provides power to the price display units attached thereto, a second contact strip provides a ground, and one or more additional contact strips provide electronic information to the various price display units attached thereto. Electrically attached to the contact strips at one end of the bus is a control unit for receiving information by any suitable means, such as an RF transmitter and receiver with repeaters in the ceiling of the store. Information is electronically transmitted to the control units from a control station having a suitable transmitter positioned in the office of the store manager. The store manager can therefore enter price changes on the screen of his computer and have those changes transmitted to the control units at the end of each of the shelves, after which the control unit will transmit the information through the contact strips of the bus to the various price display units positioned thereon.

It is common for a store to be configured into long aisles with a plurality of twenty-foot lengths of shelving positioned end-to-end. In accordance with another aspect of the invention, the ends of the busses of two adjacent lengths of shelving may be electrically connected together by connectors in end to end relationship.

Shelving is manufactured with a rigid back and a plurality of shelves extending horizontally outward of the back with the shelves positioned one above another. In accordance with another aspect of the invention, the contact strips of all the busses of the various shelves in a shelving unit are electrically connected to a single control unit, such that a single control unit will provide pricing information to every price display unit on the shelving unit. Where a plurality of shelving units are thereafter interconnected in end-to-end configuration to form elongate aisles within in the store, a single control unit can provide pricing information to all the price display units on the entire length of shelving.

In accordance with another aspect of the invention, each of the price display units has an electronic identification code printed thereon, which is readable with a scanner that is also capable of reading the stock number printed in an electronically readable code on the products on the various shelves. To facilitate the programming of the various price display units to relate the pricing unit to the product being priced, a hand held programming unit is provided for use by one of the store personnel. In this embodiment, the hand held programming unit includes a transmitter for transmitting an RF signal to the repeaters and antenna in the ceiling that connect the control units to the control station. A store employee can then use the scanner of the hand held unit to read the stock number of a product on a shelf and the identification code of a price display unit and transmit that information to the control station and software in the control station connect of the pricing information to be displayed to the price display unit having the identification code associated with the stock number of the product.

In accordance with another embodiment of the invention, each of the price display units include a detector for detecting an electronic signal. Again, the hand held programming unit is provided with a scanner for reading the stock number of the various products, and a transmitter for transmitting the stock number to the electronic detector on each of the price display units. In accordance with this embodiment, a store employee will use the scanner of the hand held unit to read a stock number of a product and then use the transmitter portion of the hand held programming unit to transmit that information to the detector on the price display unit to be associated with that product. The price display unit will receive the information from the hand held programming unit and convey it along the contact strips of the bus to the control unit. In this embodiment, the control unit further includes a transmitter for transmitting the information received from the hand held programming unit to the control station.

In accordance with another aspect of the invention, the various price display units are attachable to the bus by a mechanical connector that cannot be manually released. A tool is provided for engagement with the pricing unit for removing the pricing unit from the bus to thereby prevent or deter the theft of the price display units. Furthermore, the price display unit is attached to the bus with an attachment means that inhibits or prevents movement of the price display unit longitudinally along the bus such that the pricing units cannot be moved away from the products to which they relate.

### BRIEF DESCRIPTION OF THE DRAWINGS

A better understanding of the present invention can be had after a reading of the following detailed description taken in conjunction with the drawings wherein:

FIG. 1 is a floor plan of a store having a plurality of aisles extending between shelving having an electronic pricing device in accordance with the present invention;

FIG. 2 is a fragmentary front elevational view of a plurality of lengths of shelving forming one side of an aisle depicted in FIG. 1;

FIG. 3 is a cross-sectional view of the distal end of a single shelf having a track for receiving a removable price tag;

FIG. 4 is a cross-sectional view of a bus attachable to the track depicted in FIG. 3 for retaining a price display unit in accordance with the present invention;

FIG. 5 is a side view of a price display unit attachable to the bus depicted in FIG. 4 in accordance with the present invention, the side view taken partially in cross-section;

FIG. 6 is a fragmentary cross-sectional view of the price display unit shown in FIG. 5 assembled to the bus shown in FIG. 4, which in turn is attached to the track shown in FIG. 3;

FIG. 7 is a cross-sectional view of the bus shown in FIG. 4 taken through line 7-7 thereof;

FIG. 8 is a front elevational view of the price display unit depicted in FIG. 5;

FIG. 9 is a cross-sectional view of the price display unit shown in FIG. 5 taken through line 9-9 thereof;

FIG. 10 is a side elevational view of a tool usable to disconnect the price display unit shown in FIG. 5 from the bus shown in FIG. 4; and

FIG. 11 is a block diagram of the elements of the present invention.

### DETAILED DESCRIPTION OF PREFERRED EMBODIMENT

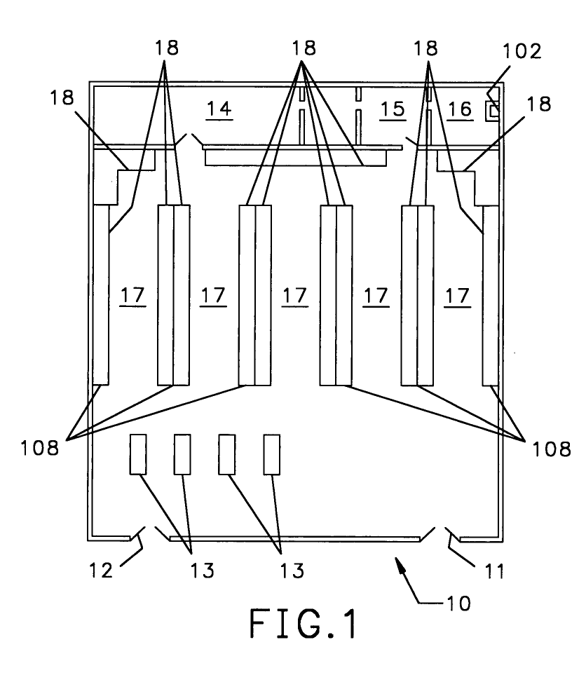

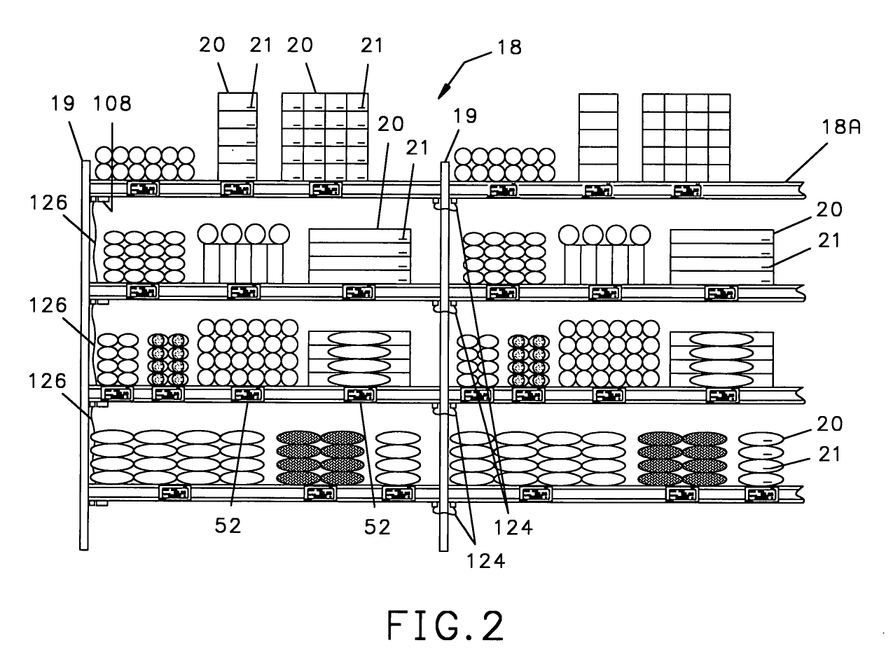

Referring to FIGS. 1 and 2, a typical store 10, such as a supermarket, has at the forward end thereof an entrance 11, an exit 12 and a plurality of check out counters 13-13. At the rear of the store are storage facilities 14 and the central offices 15 including the manager's office 16. Within the central portion of the store 10 are a plurality of parallel aisles 17-17, with the adjacent aisles 17 separated from each other by shelving 18-18, on which the goods to be sold in the store are displayed. The shelving 18-18 are typically formed in standard-sized lengths, such as 20 feet, arranged end to end, with the lengths of shelving being joined to one another by vertically-oriented support members 19-19. A length of shelving 18, therefore, will have a plurality of vertical support members 19-19 at regularly spaced intervals along the length thereof to retain the weight of products 20-20 being displayed thereon. Each product 20 displayed on a shelf 18 has a bar code 21 printed thereon readable by electronic scanner, not shown, and the bar code 21 retains a product identification number in an electronically-readable form.

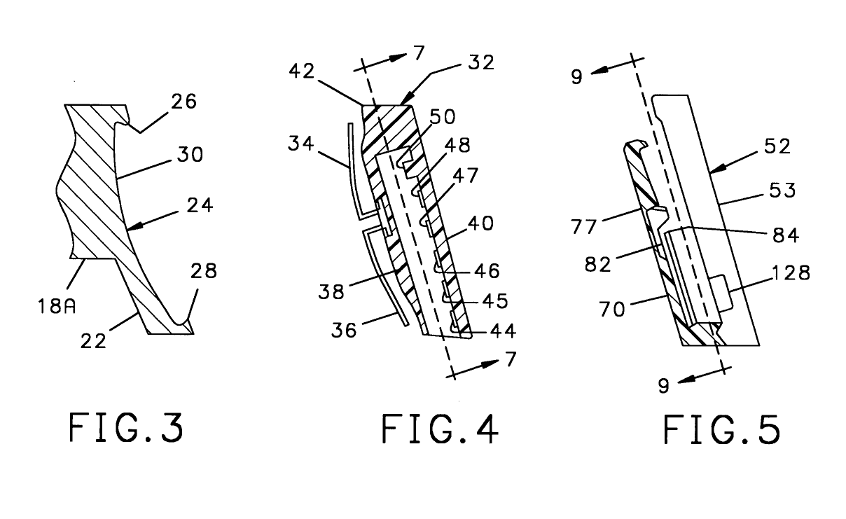

Referring to FIGS. 2 and 3, each length of shelf 18A has a rib 22 at the distal end thereof that provides structural support to the distal end of the shelf 18. The visible surface of the rib 22 is a track 24 having a downwardly-directed upper lip 26 and an upwardly-directed lower lip 28 and a concave rear surface 30 for retaining a flexible pricing member in accordance with the prior art.

In accordance with the prior art, for each product 20 on a length of shelving 18 there is positioned midway along the portion of the track 24 below the product 20, a flexible price identifier, not shown, for displaying the price of the product 20. Price changes are effectuated by removing the existing flexible price identifier, not shown, and replacing it with a substitute price identifier displaying the new price. Where a store has hundreds or perhaps thousands of goods offered for sale, changing the price identifiers for the products being offered for sale is a time-consuming task for store personnel.

Referring to FIGS. 3 through 8, in accordance with the present invention, an elongate bus 32, having an overall length equal to a standard length of shelf 18 is attachable to the track 24 at the forward end of each length of shelving 18A. To retain the bus 32 in the track 24 the bus 32 has a pair of parallel clips 34, 36 made of a spring steel, extend along the rearward surface thereof with the clips 34, 36 complementary in shape to the concave surface 30 of the track 32 and sized to be engaged within the upper and lower lips 26, 28. The spring clips 34, 36 will snap between the lips 26, 28 of the track 24 and thereby retain the bus 32 to the track 24. The spring clips 34, 36 are mounted on a rear panel 38 of the bus 32, and spaced from the rear panel 38 is a forward panel 40, with the rearward panel 38 and forward panel 40 retained in parallel relationship to each other by an upper bar 42.

The bus 32 is preferably made of a nonconductive or insulating material such as plastic, and has a rearward panel 38, and spaced therefrom and generally parallel thereto, a forward panel 40. The rearward panel 38 and the forward panel 40 are joined to each other by an upper bar 42 that extends along the length of the bus 32. Extending the length of the bus 32 and within the cavity formed between the rearward panel and the forward panel are a plurality of electrically-conductive strips 44, 45, 46, 47, 48, with each of the strips electrically insulated from one another. Also extending along the rearward surface of the forward panel 40 is an elongate rib 50 that is engagable by a tooth of a price display unit for retaining the price display unit thereto as further described below. As can be seen, when the bus 32 is attached to the track 24 of a shelf 18A, only the forward surface of the forward panel and the upper surface of the upper bar 42 are visible to the public, and the conductive strips 44-48 and the rib 50 are concealed from the public.

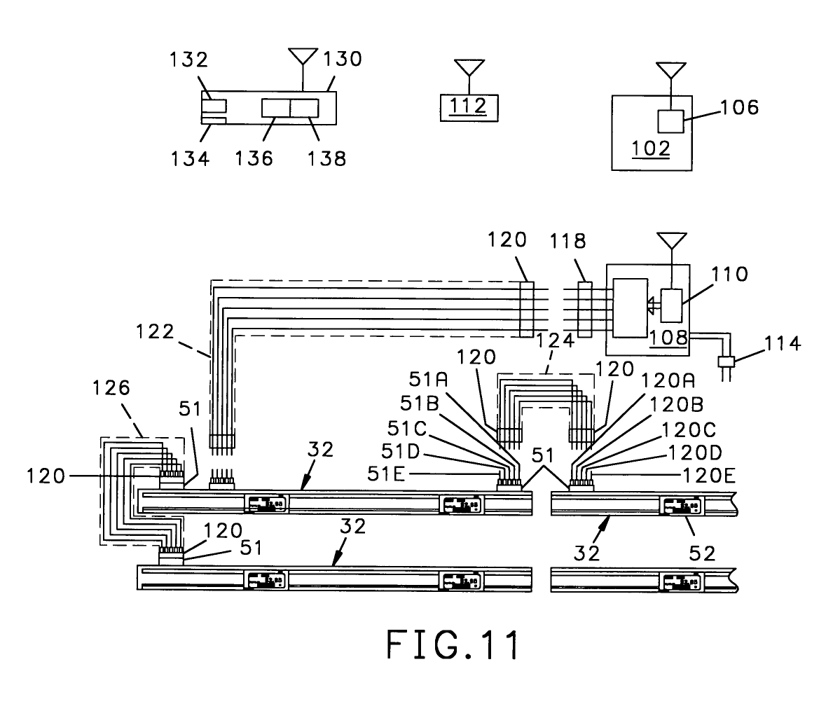

Referring to FIGS. 7 and 11, at each end of a length of bus 32 are one or more jacks 51 for receiving a connector, as is further described below. Each jack 51 has contacts 51A, 51B, 51C, 51D, 51E that are electrically connected to the conductive strips 44, 45, 46, 47, 48 respectively, such that a connector received into a jack 51 will be connected to the conductive strips 44-48.

Referring to FIGS. 4, 5, 6 and 8, an electronic price display unit 52 in accordance with the present invention is attachable to the bus 32. The price display unit 52 is generally rectangular in shape and has a forward panel 53 and mounted on the forward surface of the forward panel 53, so as to be visible to the public, is an electronic display 54, such as a liquid crystal display. Preferably the display 54 has a portion thereof 56 suitable for projecting an electronically readable bar code, such that the bar code 21 for the product 20, the price of which is being displayed, can also be projected. The electronic display 54 further has a portion thereof for projecting a product identification number 58 in a form readable by the naked eye, a portion for displaying a pricing date 60, a portion for displaying a price 62 and a sale indicator light 64 which can be illuminated, either continuously or intermittently, to indicate that the product is being offered at a sale price. A forward surface of the electronic pricing unit 52 also has an electronic detector 66 for reading an infrared or radio frequency signal transmitted by handheld wand, as further described below. Extending along the lower edge of the forward panel 53 is an elongate bar 68, and attached to the rearward end of the bar 68 is a rearward panel 70 oriented generally parallel to the forward panel 53. At the upper end of the rearward panel 70 are a pair of spaced hooks 72, 74, and between the hooks 72, 74 and the bar 68 are a plurality of contacts 76, 77, 78, 79, 80, one of which 77 is shown in cross-section in FIG. 5. As depicted in FIG. 5, each of the contacts, of which contact 77 is representative of all, is made of a spring metal and is retained in a cavity 82 and is configured to extend through an aperture 84 opening into the cavity 82 through which a portion of the contact 77 projects for engaging one of the conductive strips 44-48 of the bus 32 as is further described below.

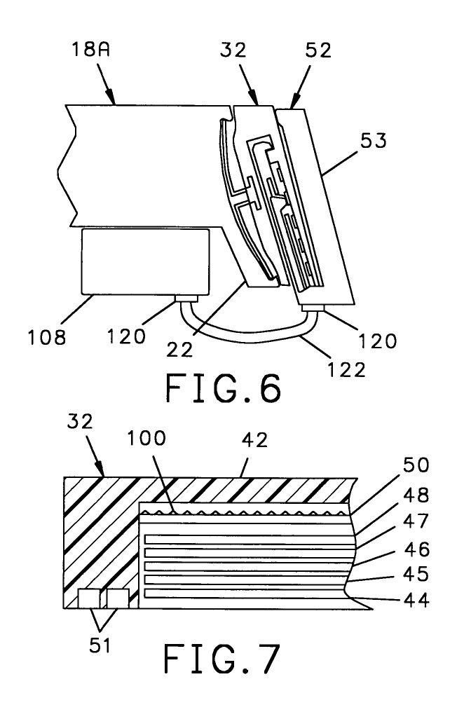

As best shown in FIGS. 5 and 6, when seen in cross-section, the price display unit 52 is U-shaped, with the forward and rearward panels 53, 70 being parallel to one another and spaced a distance apart and configured to permit the rearward panel 70 to slide between the rearward and forward panels 38, 40 of the bus 32. As best shown in FIG. 6 the hooks 72, 74 are adapted to engage the rib 50 on the rearward surface of the forward panel 40, to thereby retain the pricing unit 52 in engagement with the bus 32. Best shown in FIG. 9, the contacts 76-80 on the rearward panel 70 of the pricing unit 52 are staggered and positioned such that each one of the contacts 76-80 will engage one of the conductive strips 44-48 of the bus 32 when the price display unit 52 is attached to a bus 32.

Referring to FIGS. 6, 9 and 10, a pair of vertically-extending spaced-apart vertical holes 86, 88 extend into the rearward panel 70 with each of the holes 86, 88 aligned with one of the hooks 72, 74. A tool 90 is also provided having a handle 92, and extending from the handle 92 are a pair of rods 94, 96 spaced apart at distance equal to the spacing between the holes 86, 88 in the rearward panel 70, such that the rods 94, 96 are adapted to be slideably received within the holes 86, 88. The holes 86, 88 are angled with respect to the rear panel 70 such that when the rods 94, 96 of the tool 90 are inserted into the holes 86, 88, the hooks 72, 74 will be pushed outward of the rib 50, thereby permitting the removal of the price display unit 52 from the bus 32. Accordingly, a price display unit 52 can only be removed from a bus 32 by a store employee possessing a tool 90.

Referring further to FIGS. 6 and 9, each of the hooks 72, 74 has a serrated lower surface 98 thereon which engages a complementarily-serrated upper surface 100 on the bar 50 such that when the hooks 72, 74 engaged to the bar 50 to retain a price display unit 52 to the bus 32 the price display unit cannot be longitudinally slid along the length of the bus 32.

Referring to FIGS. 1, 2, 6 and 11, the present invention further includes a control station 102, which may be in the form of a PC with suitable software and a transmitter/receiver unit 106 for transmitting and receiving an electronic signal, such as an RF signal. The device also includes a control unit 108 that includes a transmitter and receiver 110 capable of communicating with the transmitter/receiver 106 of the control station 102, either directly or through repeaters 112 located in the ceiling of the store 10. The control unit 108 further includes a source of electric power 114, which may be in the form of batteries or may be a connector for connecting into the electrical system of the building, either hardwired or by a removable plug as shown.

The control unit 108 further includes one or more connector jacks 118 for receiving a removable connector 120 at one end of a length of cable 122 having a second connector 120 at the other end thereof. The connectors 120-120 have contacts 120A, 120B, 120C, 120D, 120E, for engaging the contacts 51A, 51B, 51C, 51D, 51E of the jacks 51 on a bus 32 to thereby connect the conductor strips 44-48 of the bus 32 to the control unit 108. As best shown in FIG. 2, the ends of the buses 32 may be connected end to end by connecting cables 124 having jacks 120 such that all the buses along a length of shelving 18A are connected together. Furthermore, the buses of a stack of shelving 18A may also be interconnected by connecting cables 126 having connectors 120 at the ends thereof such that all the buses 32 that extend along a length of shelving 18 will be connected to a single control unit 108.

In accordance with the invention, one of the conductive strips 44-48 is a power line for providing power from the control unit 108 to the various price display units 52 positioned along the lengths of bus 32. A second of the conductive strips 44-48 is a ground line, and the remaining strip or strips 44-48, in this case three, provide instructions readable by a microprocessor 128 in each of the price display units 52. Accordingly, a large number of price display units 52 may be positioned along each of the buses 32 of the various shelves 18A-18A that make up the shelving 18 along one side of an aisle 17. All of the price display units 52-52 along the shelving 18 on one side of an aisle can therefor be connected through the buses 32 to a single control unit 108. As shown in FIG. 6, the control units 108 can be inconspicuously concealed by retaining it by any suitable means, such as a magnet, below one of the shelves 18A. The transmitter/receiver 106 in the control station 102 and the complementary transmitter/receiver 110 in the control units 108 permits a store manager to set prices on the various price display units 52 throughout the store from a control station 102 located in the store manager's office 16.

In accordance with another aspect of the invention, a handheld wand 130 is also provided, which includes a scanner 132 for reading the bar codes 21 on the various products 20-20 positioned along the shelves 18-18. The wand 130 also includes an electronic transmitter 134 for transmitting a signal readable by the electronic detector 66 in each of the price display units 52. Software in the control station 102 and in the microprocessor 128 of the price display units 52 permits store personnel to coordinate a price display unit 52 to a particular product 20 by first using the scanner 132 of the wand 130 to read the product bar code 21 of a product 18, then storing the electronic reading of the bar code 21 in a memory 136 of the wand 130, and thereafter sending the electronic code 21 through the electronic transmitter 134 to the price display unit 52 by means of the detector 66 thereon.

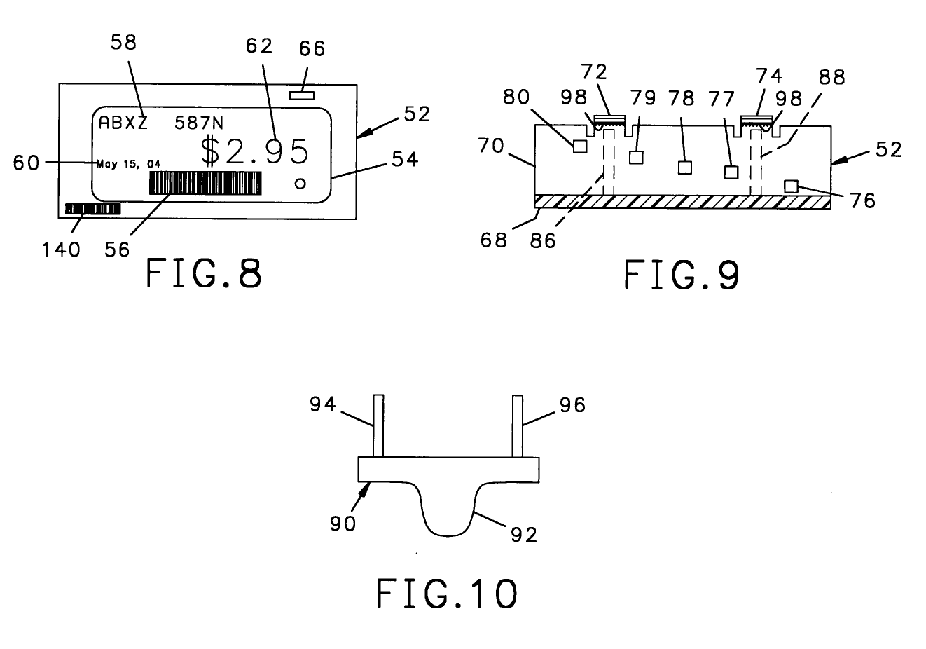

Referring to FIGS. 8 and 11, in an alternate embodiment, the wand 130 includes a transmitter 138 suitable for communicating with the transmitter/receiver 106 of the control station 102, either directly or through the repeaters 112 in the ceiling of the store 10. In this embodiment, the wand 130 may be used to read the barcode 21 on a product 18 and read a second barcode 140 on a price display unit 52 and transmit the information to the control station 102, where the price display unit 52 is aligned to display the prices of the product 18 associated therewith.

While the present invention has been described with respect to a single embodiment and certain modifications thereto, it will be appreciated that many variations and modifications may be made without departing from the true spirit and scope of the invention. It is therefore the intent of the appended claims to cover all such modifications and variations which fall within the spirit and scope of the invention.

1. A device for electronically pricing product above a shelf comprising:
a bus having a plurality of contact strips,
means for attaching said bus to said shelf,
a price display unit for electronically displaying a product price,
means for removably attaching said price display unit to said bus,
said price display unit having contacts for making electric connection to said contact strips,
a control unit for storing pricing information, and
said control unit electrically connected to said contact strips of said bus wherein said price display unit receives electric power and a display signal from said control unit through said contact strips of said bus.

2. A device for electronically pricing a plurality of products on an elongate shelf comprising:
a bus having a plurality of contact strips,
means for attaching said bus to said shelf,
a plurality of price display units, each of said price display units having means for electronically displaying a product price and having contacts for making electric connection to said contact strips,
means for removably attaching said price display units to said bus,
a control unit electrically connected to said contact strips,
said control unit providing power and a display signal to each of said plurality of price display units attached to said bus

3. The device of claim 2 wherein said bus is attachable to a price track on a shelf.

4. The device of claim 2 wherein each of said price display units are removably attachable to said bus and said device further comprises means to prevent the unauthorized removal of said price display units from said bus.

5. The device of claim 2 and further comprising:
said price display units having a receiver for receiving an electromagnetic communication,
a stock number printed in an electronically readable code on each of said plurality of products on said shelf,
a handheld programming unit including a transmitter and a scanner for reading said electronic codes wherein said scanner can be used to read said stock number for one of said products and said transmitter can be used to transmit said stock number for said one of said products to one of said price display units.

6. The device of claim 2 and further comprising means to lock said price display units against sliding movement along said bus.

7. The device in accordance with claim 2 wherein
said control unit includes a receiver, and said device further comprising
a control station remote from said bus and said control unit, and
said control station including a transmitter wherein pricing information inserted into said control station is transmitted to said control unit and displayed on said plurality of price display units.

8. The device of claim 7 and further comprising:
a stock number printed in an electronically readable code on said products on said shelf,
an electronic identification code printed on each of said plurality of price display units,
a handheld programming unit including a transmitter and scanner for reading said electronic codes wherein said programming unit can read said electronically readable code for one of said products and read said identification code for one of said plurality of price display units and transmit said codes to said control stations, and
means for linking said codes wherein said control station will transmit pricing information for said one of said products to said control station to be displayed on said one of said plurality of price display units.

9. The device of claim 8 and further comprising:
a stock number printed in an electronically readable code on each of said products on said shelf,
each said price display unit including a detector for detecting an electronic signal, and each of said display units having a coded unit identifier, said control unit including a transmitter for transmitting information to said control station,
a handheld programming unit having a scanner for reading said electronically readable code on said products and a transmitter for transmitting an electric signal to said detector on one of said price display units wherein said scanner can record said stock number for one of said products and transmit said stock number to one of said display units such that said stock number and said unit identifier for said one of said price display units will be transmitted to said control unit, and
means for linking said stock number and said unit identifiers wherein pricing information for said one of said products is displayed on said one of said display units.
